(19) United States
(12) Patent Application Publication
(10) Pub. No.: US 2026/0124954 A1
(43) Pub. Date: May 7, 2026

(54) BATTERY MONITORING SYSTEM AND WIRELESS COMMUNICATION METHOD

(71) Applicant: DENSO CORPORATION, Kariya-city (JP)

(72) Inventor: Yuto HONDA, Kariya-city (JP)

(73) Assignee: DENSO CORPORATION, Kariya-city (JP)

(21) Appl. No.: 19/434,878

(22) Filed: Dec. 29, 2025

Related U.S. Application Data
(63) Continuation of application No. PCT/JP2024/019635, filed on May 29, 2024.

(30) Foreign Application Priority Data
Jun. 29, 2023 (JP) 2023-107030

(51) Int. Cl. B60L 58/10; G07C 5/00; H04W 4/48; H04W 72/542

(52) U.S. Cl. CPC B60L 58/10; G07C 5/008; H04W 4/48; H04W 72/542; B60L 2240/12; B60L 2240/70

(57) ABSTRACT

In a battery monitoring system, a receiver executes, in accordance with received control information transmitted from a transceiver, at least one control process. The receiver determines whether a communication quality of the communication channel used for transmission of the control information is favorable in response to reception of the control information. The receiver returns a result of the at least one control process to the transmitter upon determination that the communication quality of the communication channel is favorable, and does not return the result of the at least one control process to the transmitter upon determination that the communication quality of the communication channel is unfavorable.

### CROSS-REFERENCE TO RELATED APPLICATION

This present application is a bypass continuation application of currently pending international application No. PCT/JP2024/019635 filed on May 29, 2024 designating the United States of America, the entire disclosure of which is incorporated herein by reference, the international application being based on and claiming the benefit of priority from Japanese Patent Application No. 2023-107030 filed on June 29, 2023, the disclosure of which is incorporated herein by reference.

### TECHNICAL FIELD

The present disclosure relates to battery monitoring systems, transmitters for a battery monitoring system, receivers for a battery monitoring system, wireless communication program products, and wireless communication methods.

### BACKGROUND

In recent years, battery monitoring systems have been developed, which transmit or receive battery information through wireless communication. A secondary unit included in a battery monitoring system selected from these battery monitoring systems is configured to transmit, together with battery information, additional information to a primary unit; the additional information is associated with a reception condition through each communication channel. The primary unit determines the communication quality for each communication channel based on the received reception-condition information and uses the determined communication quality for each communication channel to select one or more of the communication channels for subsequent battery-information transmissions. Such a selected battery monitoring system is disclosed in Japanese Patent Publication No. 6514694.

### SUMMARY

In such a conventional battery monitoring system, each time the secondary unit transmits the battery information to the primary unit, the secondary unit transmits the additional information associated with the reception condition through each communication channel to the primary unit. This may result in an increase in the amount of communication data transmitted from the secondary unit to the primary unit. An increase in the amount of communication data transmitted from the secondary unit to the primary unit may cause the communication speed between the primary and secondary units to slow, resulting in a higher communication error rate.

In view of the above circumstances, the present disclosure seems to provide battery monitoring systems, transmitters for a battery monitoring system, receivers for a battery monitoring system, wireless communication program products, and wireless communication methods, each of which is capable of reducing the amount of communication data.

A first exemplary aspect of the present disclosure provides a battery monitoring system for monitoring a battery unit. The battery monitoring system includes a transmitter configured to wirelessly transmit control information through a selected communication channel from a plurality of communication channels, and a receiver includes a control circuitry configured to cause the receiver to receive the control information transmitted from the transmitter, and execute, in accordance with the control information, at least one control process. The control circuitry is configured to cause the receiver to determine whether a communication quality of the communication channel used for transmission of the control information in response to reception of the control information is favorable, and return a result of the at least one control process to the transmitter upon determination that the communication quality of the communication channel is favorable. The control circuitry is configured to cause the receiver not to return the result of the at least one control process to the transmitter upon determination that the communication quality of the communication channel is unfavorable. The transmitter includes an evaluation circuitry configured to determine whether the result of the at least one control process has been returned thereto from the receiver after transmission of the control information, and evaluate that the communication quality of the communication channel used for transmission of the control information is unfavorable upon determination that the result of the at least one control process has not been returned thereto from the receiver.

The first exemplary aspect prevents returning of the result of the at least one control process upon determination that the communication quality of the communication channel is unfavorable. Therefore, it is possible to prevent the vicious cycle in which the amount of communication data increases in order to indicate that the communication quality is unfavorable, thus suppressing further degradation of the communication quality.

A second exemplary aspect of the present disclosure provides a receiver for a battery monitoring system that monitors a battery unit. A transmitter of the battery monitoring system is configured to wirelessly transmit control information through a selected communication channel from a plurality of communication channels.

The receiver includes a control circuitry configured to cause the receiver to receive the control information transmitted from the transmitter, execute, in accordance with the control information, at least one control process, determine whether a communication quality of the communication channel used for transmission of the control information is favorable in response to reception of the control information, and return a result of the at least one control process to the transmitter upon determination that the communication quality of the communication channel is favorable. The control circuitry is configured to cause the receiver not to return the result of the at least one control process to the transmitter upon determination that the communication quality of the communication channel is unfavorable.

The second exemplary aspect prevents returning of the result of the at least one control process upon determination that the communication quality of the communication channel is unfavorable. Therefore, it is possible to prevent the vicious cycle in which the amount of communication data increases in order to indicate that the communication quality is unfavorable, thus suppressing further degradation of the communication quality.

A third exemplary aspect of the present disclosure provides a transmitter for a battery monitoring system that monitors a battery unit. A receiver of the battery monitoring system is configured (i) to execute, in accordance with control information, at least one control process, (ii) to determine whether a communication quality of a communication channel used for transmission of the control information is favorable in response to reception of the control information, (iii) to return a result of the at least one control process to the transmitter upon determination that the communication quality of the communication channel is favorable, and (iv) not to return the result of the at least one control process to the transmitter upon determination that the communication quality of the communication channel is unfavorable.

The transmitter is configured to transmit the control information to the receiver through the communication channel, and includes an evaluation circuitry. The evaluation circuitry is configured to determine whether the result of the at least one control process has been returned thereto from the receiver after transmission of the control information, and evaluate that the communication quality of the communication channel used for transmission of the control information is unfavorable upon determination that the result of the at least one control process has not been returned thereto from the receiver.

The third exemplary aspect prevents returning of the result of the at least one control process upon determination that the communication quality of the communication channel is unfavorable. Therefore, it is possible to prevent the vicious cycle in which the amount of communication data increases in order to indicate that the communication quality is unfavorable, thus suppressing further degradation of the communication quality.

A fourth exemplary aspect of the present disclosure provides a wireless communication program product for a battery monitoring system that comprises a transmitter and a receiver and monitors a battery unit. The program product includes one or more non-transitory storage media, and program instructions stored in the non-transitory storage media. The program instructions cause the receiver to (i) execute, in accordance with control information, at least one control process, determine whether a communication quality of a communication channel used for transmission of the control information is favorable in response to reception of the control information, and (iii) return a result of the at least one control process to the transmitter upon determination that the communication quality of the communication channel is favorable. The program instructions cause the receiver not to return the result of the at least one control process to the transmitter upon determination that the communication quality of the communication channel is unfavorable. The program instructions cause the transmitter to wirelessly transmit control information through a selected communication channel from a plurality of communication channels, and determine whether the result of the at least one control process has been returned thereto from the receiver after transmission of the control information. The program instructions cause the transmitter to evaluate that the communication quality of the communication channel used for transmission of the control information is unfavorable upon determination that the result of the at least one control process has not been returned thereto from the receiver.

The fourth exemplary aspect prevents returning of the result of the at least one control process upon determination that the communication quality of the communication channel is unfavorable. Therefore, it is possible to prevent the vicious cycle in which the amount of communication data increases in order to indicate that the communication quality is unfavorable, thus suppressing further degradation of the communication quality.

A fifth exemplary aspect of the present disclosure provides a wireless communication method includes (i) wirelessly transmitting, by a transmitter, control information through a selected communication channel from a plurality of communication channels, (ii) receiving, by a receiver, the control information transmitted from the transmitter, (iii) executing, by the receiver, at least one control process in accordance with the control information, (iv) determining, by the receiver, whether a communication quality of the communication channel used for transmission of the control information in response to reception of the control information is favorable, (v) returning, by the receiver, a result of the at least one control process to the transmitter upon determination that the communication quality of the communication channel is favorable, (vi) not returning, by the receiver, the result of the at least one control process to the transmitter upon determination that the communication quality of the communication channel is unfavorable, (vii) determining, by the transmitter, whether the result of the at least one control process has been returned thereto from the receiver after transmission of the control information, and (viii) evaluating, by the transmitter, that the communication quality of the communication channel used for transmission of the control information is unfavorable upon determination that the result of the at least one control process has not been returned thereto from the receiver.

The fifth exemplary aspect prevents returning of the result of the at least one control process upon determination that the communication quality of the communication channel is unfavorable. Therefore, it is possible to prevent the vicious cycle in which the amount of communication data increases in order to indicate that the communication quality is unfavorable, thus suppressing further degradation of the communication quality.

### BRIEF DESCRIPTION OF THE DRAWINGS

Other aspects of the present disclosure will become apparent from the following description of embodiments with reference to the accompanying drawings in which:

FIG. 1 is a block diagram illustrating a schematic configuration of a vehicle;

FIG. 2 is a block diagram illustrating a configuration of a battery pack illustrated in FIG. 1;

FIG. 3 is a perspective view illustrating a schematic configuration of the battery pack;

FIG. 4 is a sequence diagram illustrating data communication processes according to the first embodiment;

FIG. 5 is a sequence diagram illustrating the data communication processes according to the first embodiment;

FIG. 6 is a sequence diagram illustrating a connection-establishment process;

FIG. 7 is a diagram illustrating communication channels within a predetermined frequency band;

FIG. 8 is a diagram illustrating a data flow at establishment of a communication channel;

FIG. 9 is a diagram illustrating a channel map according to the first embodiment;

FIG. 10 is a sequence diagram illustrating data communication processes according to the second embodiment;

FIG. 11 is a diagram illustrating a channel map according to the second embodiment;

FIG. 12 is a flowchart illustrating a system abnormality determination routine according to the third embodiment; and

FIG. 13 is a flowchart illustrating a secondary abnormality determination routine according to the fourth embodiment.

### DETAILED DESCRIPTION OF EMBODIMENTS

The following describes exemplary embodiments of a battery monitoring system, a transmitter, a receiver, a wireless communication program, and a wireless communication method according to the present disclosure in detail with reference to the accompanying drawings.

In the embodiments and modifications, identical or corresponding elements in the drawings are denoted by the same reference numerals, and their descriptions are generally not repeated. The following descriptions focus on application of the present disclosure to a vehicle, but the present disclosure can also be used to non-vehicle applications, such as aircraft including drones, ships, construction machinery, and agricultural machinery.

### First embodiment

### Vehicle

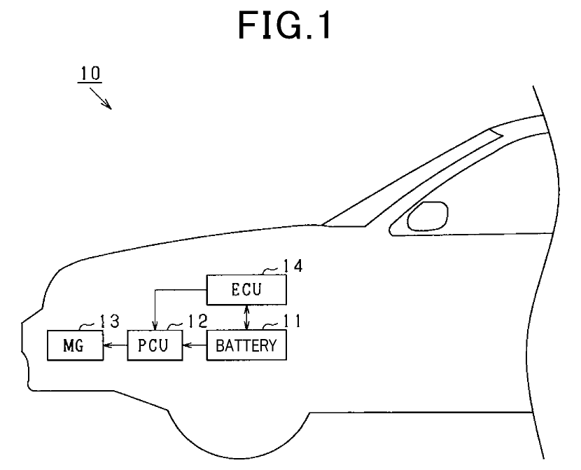

FIG. 1 schematically illustrates the configuration of a vehicle 10. The vehicle 10 is an electrified vehicle, such as an electric vehicle (EV), a hybrid vehicle (HV), or a plug-in hybrid vehicle (PHV). The vehicle 10 includes a battery pack 11 (indicated as “BATTERY” in FIG. 1), a power control unit (PCU) 12 serving as a power converter, a motor 13 serving as an electric load (indicated as “MG” in FIG. 1), and a vehicle ECU 14 (indicated as “ECU” in FIG. 1). PCU is an abbreviation for “Power Control Unit,” MG is an abbreviation for “Motor Generator,” and ECU is an abbreviation for “Electronic Control Unit.”

The battery pack 11 is mounted to the vehicle 10 as a drive power source for the vehicle 10. In FIG. 1, the battery pack 11 is disposed in, for example, a front compartment of the vehicle 10. The battery pack 11 may alternatively be disposed in a rear compartment, under a seat, under a floor, or at another suitable location of the vehicle 10.

The battery pack 11 includes a cell assembly 20, which is described later, and serves as a rechargeable direct-current (DC) voltage source. The battery pack 11 supplies electric power to electrical loads of the vehicle 10. The battery pack 11 also supplies electric power to the motor 13 after being converted by the PCU 12. The battery pack 11 is configured to be chargeable via the PCU 12.

The PCU 12 performs bidirectional power conversion between the battery pack 11 and the motor 13 in accordance with a control signal sent from the vehicle ECU 14. The PCU 12 includes, for example, an inverter that converts a DC voltage from the battery pack 11 into an alternating-current (AC) voltage to drive the motor 13 and a converter that boosts the DC voltage supplied to the inverter to a voltage higher than an output voltage of the battery pack 11.

The motor 13 is an AC rotating electric machine, such as, a three-phase AC synchronous motor including a rotor and permanent magnets embedded in the rotor. The motor 13 is driven by the PCU 12 to generate rotational driving force, which is transmitted to drive wheels of the vehicle 10. When braking the vehicle 10, the motor 13 operates as a power generator to perform regenerative power generation. Electric power generated by the motor 13 is supplied to the battery pack 11 via the PCU 12 and stored in the cell assembly 20 of the battery pack

The vehicle ECU 14 includes a CPU, a ROM, a RAM, input/output ports for inputting and outputting various signals, and other peripheral devices. The CPU loads programs stored in the ROM to the RAM and executes the programs in the RAM. Each program stored in the ROM describes a corresponding process to be executed by the vehicle ECU 14. As one example of main processing of the vehicle ECU 14, the vehicle ECU 14 receives information such as a voltage, a current, a state of charge (SOC), and a state of health (SOH) of the cell assembly 20 from the battery pack 11, and controls the PCU 12 to accordingly instruct driving of the motor 13 and charging or discharging of the battery pack 11.

### Battery Pack

The following describes the battery pack 11 in detail.

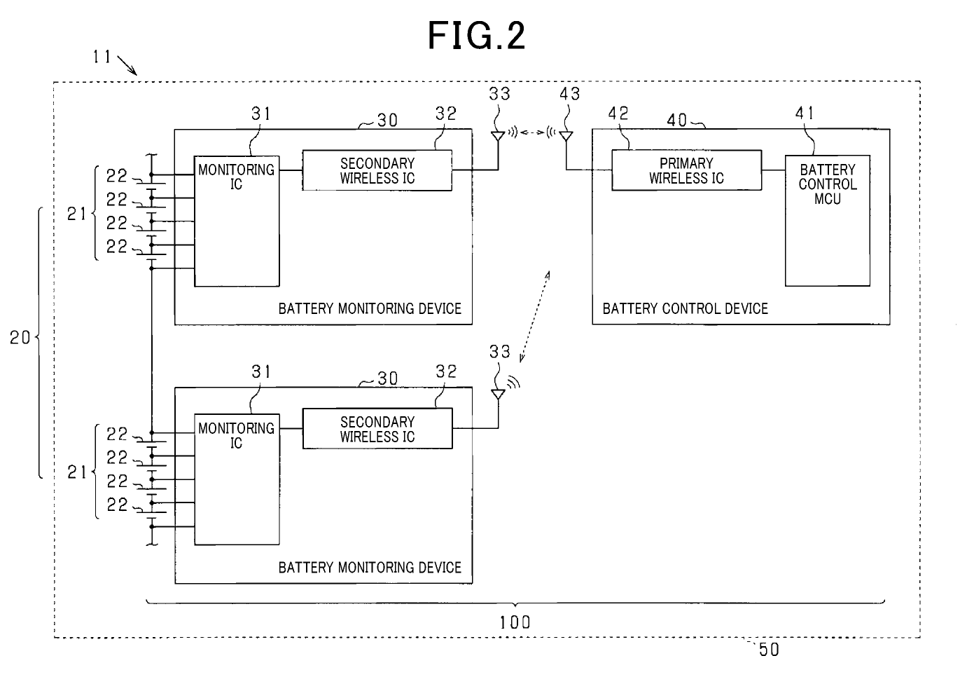

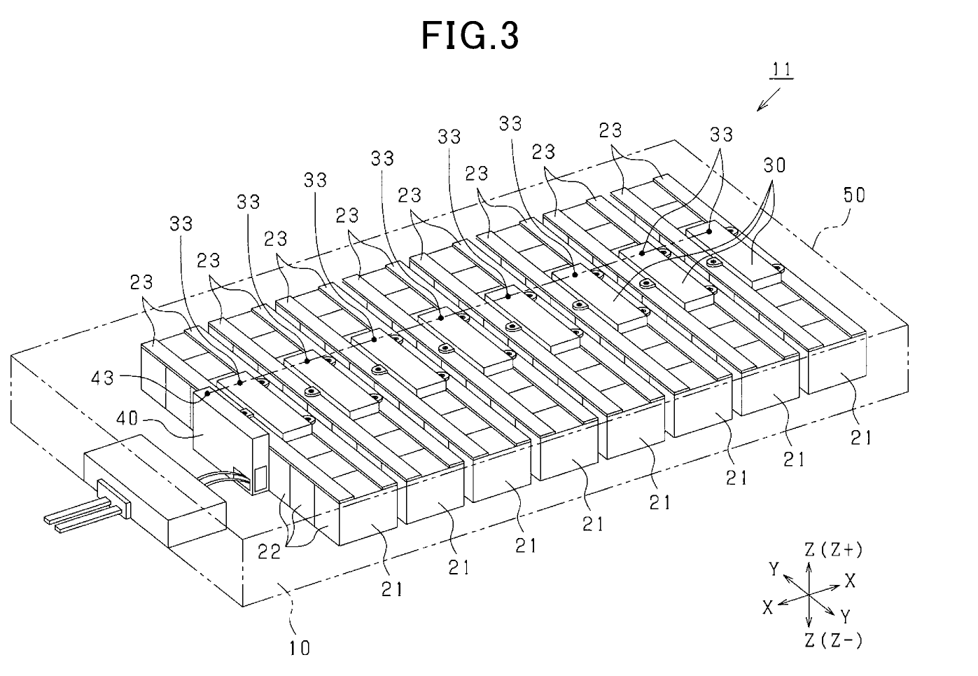

FIG. 2 is a block diagram illustrating an electrical configuration of the battery pack 11, and FIG. 3 is a perspective view illustrating a schematic configuration/appearance of the battery pack 11.

The battery pack 11 includes the cell assembly 20, a battery monitoring system 100, and a housing 50, which is indicated by dash-dot-dot lines in FIG. 3. The housing 50 is arranged to accommodate the cell assembly 20 and the battery monitoring system 100. The battery monitoring system 100 is configured to monitor and manage the cell assembly 20 using wireless communication. The battery monitoring system 100 includes a plurality of battery monitoring devices 30 and a battery control device 40; each battery monitoring device 30 and the battery control device 40 are configured to perform wireless communications therebetween. The wireless communications use a selected frequency band, such as a 2.4-GHz band or a 5-GHz band.

### Cell Assembly

The cell assembly 20 includes a plurality of battery blocks 21, which are also referred to as battery stacks or battery modules. Connecting the battery blocks 21 in series and/or in parallel to one another constitutes the cell assembly 20.

Each battery block 21 includes a plurality of battery cells 22. Each battery cell 22 is formed of, for example, a lithium-ion secondary battery or a nickel-metal hydride secondary battery. The lithium-ion secondary battery is a secondary battery that uses lithium as a charge carrier and may include not only a typical lithium-ion secondary battery having a liquid electrolyte but also a so-called solid-state battery using a solid electrolyte. Connecting the battery cells 22 in series and/or in parallel to one another via busbars 23 constitutes the battery block 21. The provision of the battery block 21 is optional. That is, connecting the battery cells 22 in series and/or in parallel to one another via busbars 23 without defining distinct battery blocks 21 may constitute the cell assembly 20.

### Battery Monitoring Device

The following describes the battery monitoring devices 30. The configuration of each battery monitoring device 30 is common. The battery monitoring device 30 is also referred to as a satellite battery module (SBM). Each battery monitoring device 30 is provided for the corresponding battery block 21, that is, for the group of battery cells 22 included in the corresponding battery block 21.

As shown in FIG. 2, each battery monitoring device 30 includes a monitoring integrated circuit (IC) 31, a secondary wireless IC 32, and a secondary wireless antenna 33, and other devices. In each battery monitoring device 30, the secondary wireless IC 32 is wired to the monitoring IC 31, and the secondary wireless IC 32 is wired to the secondary wireless antenna 33.

The monitoring IC 31, which is also referred to as a cell supervising circuit (CSC), acquires, i.e., measure, battery information on each battery cell 22 constituting the battery block 21 via unillustrated physical-quantity detection sensors. The physical-quantity detection sensors include, for example, voltage sensors, temperature sensors, and current sensors, and the battery information includes, for example, information on a voltage across each battery cell 22, a temperature of each battery cell 20, and a current from/to each battery cell 22. The monitoring target of the battery monitoring device 30 may be the battery block 21 or may be the entire cell assembly 20 and may be freely changed therebetween.

When receiving data, such as control data as control information, that requests acquisition and transmission of the battery information, the monitoring IC 31 acquires the battery information in accordance with the control data, and transmits, as a control result, monitoring data including at least the battery information. The monitoring IC 31 may execute failure diagnosis, which includes self-diagnosis, of circuit portions of the battery monitoring device 30 including the monitoring IC 31 itself, and may have a function of transmitting the monitoring data including, in addition to the acquired battery information, a result of the failure diagnosis. That is, the monitoring IC 31 serves as a control circuitry, i.e., a control circuit or a control processor, that performs control of the battery monitoring device 30.

The secondary wireless IC 32 includes an RF circuit, a microcontroller, a front-end circuit, and other components (not shown) for wirelessly transmitting and receiving data. The secondary wireless IC 32 has a transmission function for modulating data and outputting the modulated data as an RF signal oscillated at a radio frequency. The secondary wireless IC 32 also has a reception function for receiving an RF signal and demodulating the received RF signal to obtain data included in the received RF signal. RF is an abbreviation for “radio frequency.”

The secondary wireless IC 32 modulates monitoring data including the battery information received from the monitoring IC 31 and transmits the monitoring data to the battery control device 40 via the secondary wireless antenna 33. At that time, the secondary wireless IC 32 adds data required for wireless communication, such as communication control information, to the monitoring data including the battery information and transmits the monitoring data to which the data required for wireless communication has been added. The data required for wireless communication includes, for example, an identifier (ID) and an error detection code. The secondary wireless IC 32 also has functions of determining a data size, a communication format, and a schedule for communication between the battery monitoring device 30 and the battery control device 40, and of detecting errors associated with, for example, the communication.

The secondary wireless IC 32 also receives data wirelessly transmitted from the battery control device 40 via the secondary wireless antenna 33 and demodulates the data. When the secondary wireless IC 32 receives control data including, for example, a request for acquisition and transmission of battery information, the secondary wireless IC 32 transmits (forwards) the control data by wire to the monitoring IC 31. In response to the request, when the secondary wireless IC 32 receives monitoring data including battery information from the monitoring IC 31, the secondary wireless IC 32 modulates response data including the monitoring data and wirelessly transmits the response data to the battery control device 40 via the secondary wireless antenna 33.

The secondary wireless antenna 33 converts the RF signal, which is an electric signal, sent from the secondary wireless IC 32 into radio waves and radiates the radio waves into space. Additionally, the secondary wireless antenna 33 receives radio waves propagating through space and converts the radio waves into an electric signal.

### Battery Control Device

The battery control device 40, which is also referred to as a battery ECU or a battery management unit (BMU), is capable of wireless communication with each battery monitoring device 30.

More specifically, as shown in FIG. 2, the battery control device 40 includes a battery control MCU 41, a primary wireless IC 42, and a primary wireless antenna 43, and other devices. The primary wireless IC 42 is wired to the battery control MCU 41, and the primary wireless IC 42 is wired to the primary wireless antenna 43.

The battery control MCU 41 is comprised of a micro controller unit (MCU) including a CPU, a ROM, a RAM, an input/output interface, and other peripheral devices. The CPU of the battery control MCU 41 loads programs stored in the ROM to the RAM and executes the programs in the RAM. Each program stored in the ROM describes, for example, a corresponding process related to control of the cell assembly 20.

As one example of main processing of the battery control MCU 41, the battery control MCU 41 transmits control data that requests acquisition and transmission of the battery information to each battery monitoring device 30. The battery control MCU 41 additionally performs various operations related to monitoring of the cell assembly 20, the battery blocks 21, and the battery cells 22 in accordance with the monitoring data including the battery information received from each battery monitoring device 30.

For example, the battery control MCU 41 may transmit, as a monitoring result, the monitoring data to the vehicle ECU 14 that serves as an upper-level ECU. In this example, the battery control MCU 41 may calculate the SOC and/or the SOH of, for example, the cell assembly 20 based on the battery information, and transmit the battery information including the calculated SOC and SOH of the cell assembly 20 to the vehicle ECU 14. The battery control MCU 41 may additionally perform, based on, for example, the monitoring result, switching control of relay switches that switch between an energized state and a de-energized state between (i) the cell assembly 20 and the PCU 12 and (ii) the cell assembly 20 and the motor 13.

The battery control MCU 41 may further transmit equalization signals for equalizing the voltages across the respective battery cells 22. In the first embodiment, the vehicle ECU 14 instructs the PCU 12 to perform charging/discharging control of the cell assembly 20, but the battery control MCU 41 may instruct the PCU 12 to perform charging/discharging control of the cell assembly 20 in place of the vehicle ECU 14. As described above, the battery control MCU 41 performs monitoring and management of the cell assembly 20, the battery blocks 21, and the battery cells 22.

The primary wireless IC 42, similarly to the secondary wireless IC 32, includes an RF circuit, a microcontroller, a front-end circuit, and other components (not illustrated) for wirelessly transmitting and receiving data. The primary wireless IC 42 has transmission and reception functions similar to those of the secondary wireless IC 32.

The primary wireless IC 42 demodulates the monitoring data including the battery information received via the primary wireless antenna 43, and transmits the monitoring data to the battery control MCU 41. The primary wireless IC 42 also adds data required for wireless communication, such as communication control information, to the control data received from the battery control MCU 41, and modulates the control data to which the data required for wireless communication has been added. Then, the primary wireless MCU 42 transmits the modulated control data to the battery monitoring device 30 via the primary wireless antenna 43. The data required for wireless communication includes, for example, an ID and an error detection code. The primary wireless IC 42 also has functions of determining a data size, a communication format, and a schedule for communication between the battery monitoring device 30 and the battery control device 40, and of detecting errors associated with, for example, the communication.

The primary wireless antenna 43 has a configuration and functions similar to those of the secondary wireless antenna 33. Specifically, the primary wireless antenna 43 converts the RF signal, which is an electric signal, sent from the primary wireless MCU 41 into radio waves and radiates the radio waves into space. Additionally, the primary wireless antenna 43 receives radio waves propagating through space and converts the radio waves into an electric signal.

### Housing

The housing 50 is formed of a conductive material such as metal. For example, the housing 50 has a box-like metal structure and is substantially rectangular parallelepiped. Part or all of the housing 50 may be formed of a non-conductive member such as resin. The housing 50 accommodates the cell assembly 20, the battery monitoring devices 30, and the battery control device 40.

The following briefly describes the arrangement of the cell assembly 20, the battery monitoring devices 30, and the battery control device 40 with reference to FIG. 3. The housing 50 has a bottom surface to be mounted to the vehicle 10. As shown in FIG. 3, the battery blocks 21, which constitute the cell assembly 20, are arranged side by side in a longitudinal direction of the housing 50 in the substantially rectangular-parallelepiped housing 50; the longitudinal direction corresponds to an X-direction in FIG. 3. In each battery block 21, the battery cells 22, which constitutes the corresponding battery block 21, are arranged in a stacked manner in a lateral direction of the housing 50; the lateral direction corresponds to a Y-direction in FIG. 3.

One battery monitoring device 30 and two busbars 23 are disposed on an upper surface (a surface on a +Z-direction side in FIG. 3) of each battery block 21 so as to be fixed thereto by, for example, screws. The battery control device 40 is positioned on the outside of the array of the battery blocks 21 in the longitudinal direction (X-direction). For example, the battery control device 40 is mounted on, for example, a circuit board, and the circuit board on which the battery control device 40 is mounted is attached to a side surface of a selected one of the battery blocks 21, which is located at the outermost end in the X direction according to the first embodiment, such that the circuit board extends vertically, i.e., in the Z direction. Preferably, the primary wireless antenna 43 of the battery control device 40 is arranged to project above the upper surfaces of the battery blocks 21.

The arrangement of the cell assembly 20, the battery monitoring devices 30, and the battery control device 40 shown in FIG. 3 is merely an example and may be changed as desired. In the first embodiment, the cell assembly 20 and the battery monitoring system 100 are accommodated inside the housing 50, but part of the cell assembly 20 and the battery monitoring system 100 may be disposed outside the housing 50. For example, the cell assembly 20 and the battery monitoring system 100 may be directly mounted to a body frame of the vehicle 10 without providing the housing 50, so that the body frame of the vehicle 10 serves as a housing of the cell assembly 20 and the battery monitoring system 100.

### Wireless Communication

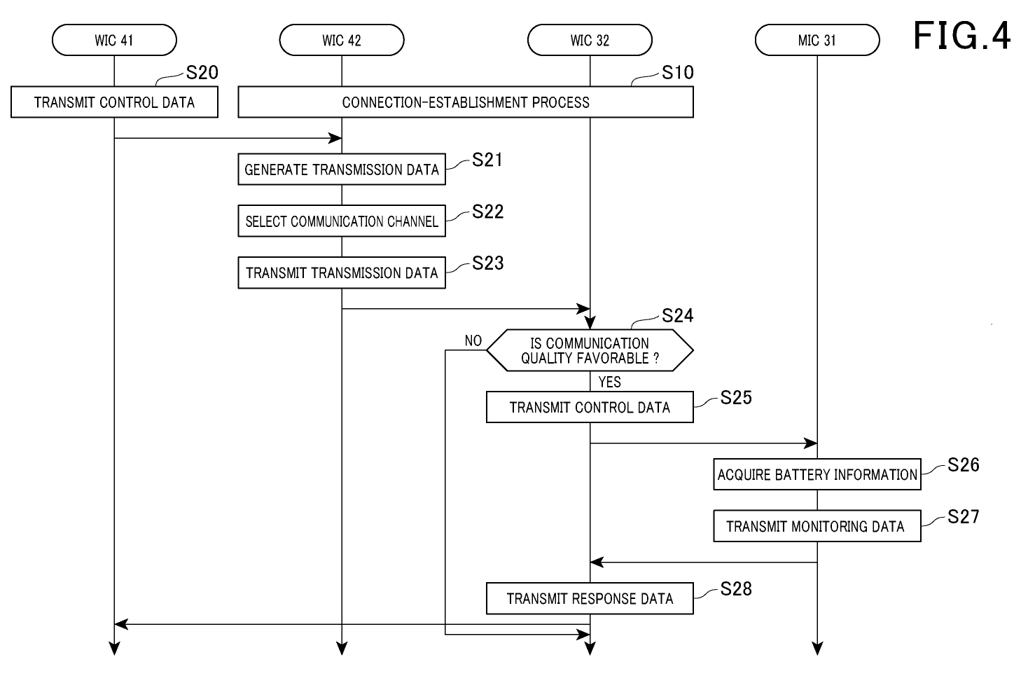

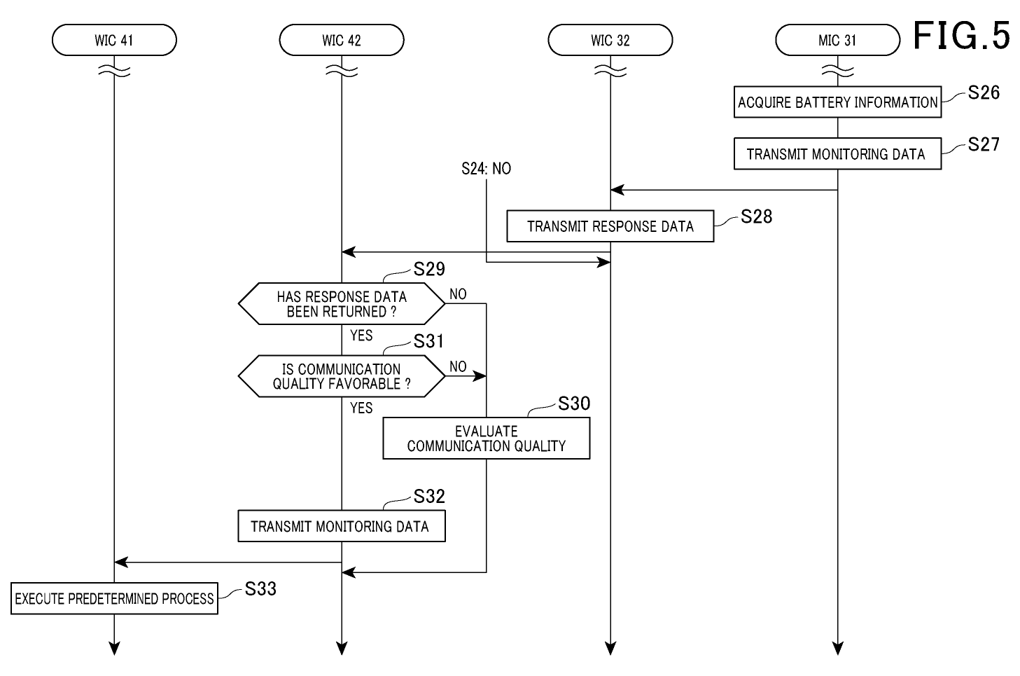

The following describes wireless communication (wireless communication method) between one of the battery monitoring devices 30 and the battery control device 40 with reference to FIGS. 4 to 6. FIGS. 4 and 5 illustrate an example of a communication sequence for data communication between the battery monitoring device 30 and the battery control device 40. This communication sequence is repeated every predetermined period or is executed in accordance with a predetermined communication schedule. Each of the battery monitoring devices 30 and the battery control device 40 executes a wireless communication program stored in its storage, such as its ROM, to execute corresponding processes included in the communication sequence illustrated in FIGS. 4 and 5.

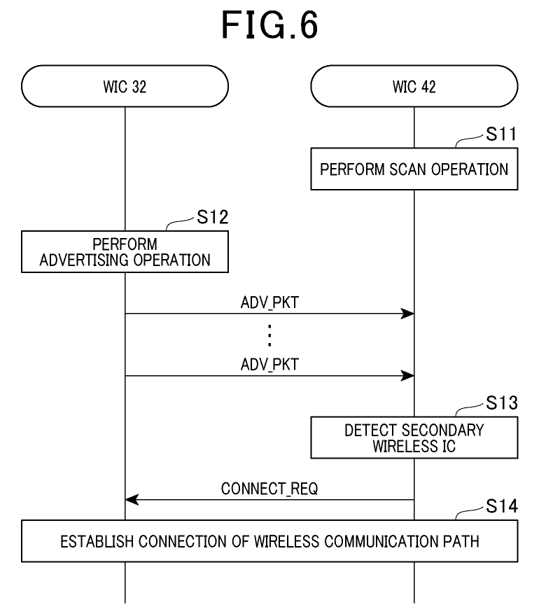

As described above, FIGS. 4 to 6 illustrate a wireless communication routine between one of the battery monitoring devices 30 and the battery control device 40. One of the battery monitoring devices 30, which serves as a communication partner of the battery control device 40, is determined by, for example, the communication schedule. In FIGS. 4 to 6, the monitoring IC 31 is denoted as MIC 31, the secondary wireless IC 32 is denoted as WIC 32, the battery control MCU 41 is denoted as MCU 41, and the primary wireless IC 42 is denoted as WIC 42. FIG. 6 illustrates an example of a connection-establishment process in step S10 shown in FIG. 4.

As shown in FIG. 4, the secondary wireless IC 32 of the battery monitoring device 30 and the primary wireless IC 42 of the battery control device 40 execute the connection-establishment process for establishing a connection therebetween in step S10.

The following describes the connection-establishment process in step S10 with reference to FIG. 6.

As shown in FIG. 6, the primary wireless IC 42 of the battery control device 40 performs a scan operation, i.e., an operation of detecting a secondary wireless IC, in step S11, and the secondary wireless IC 32 of the battery monitoring device 30 serving as the communication partner performs an advertising operation, i.e., a connection-information transmission operation in step S12. The primary wireless IC 42 may start the scan operation before the advertising operation, at substantially the same timing, or after the advertising operation.

The secondary wireless IC 32 performs, as the advertising operation, an operation of transmitting an advertisement packet (ADV_PKT) through broadcast communication in order to inform the primary wireless IC 42 of the battery control device 40 about the presence of the secondary wireless IC 32 of the battery monitoring device 30. The advertisement packet includes, for example, ID information on the secondary wireless IC 32 of the battery monitoring device 30 and ID information on the battery control device 40.

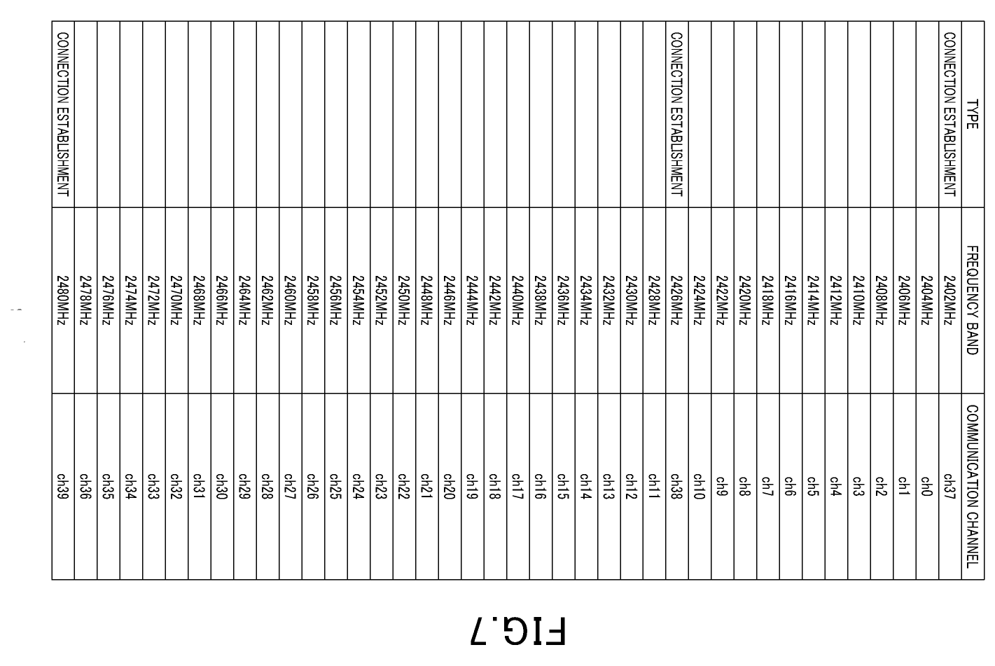

The advertising operation selectively uses one or more of multiple communication channels. Each of the communication channels corresponds to a divided segment of a frequency band, such as the 2.4 GHz band used in short-range communication, defined by a predetermined bandwidth (e.g., 2 MHz). In the first embodiment, as shown in FIG. 7, the frequency band is divided into 40 communication channels of channel 0 (0ch) to channel 39 (39ch). The connection-establishment communication channels are predetermined channels (for example, channel 37 to channel 39) among the total range from the channel 0 to the channel 39. The other channels among the total range from the channel 0 to the channel 39, such as channel 0 to channel 36, serve as data-transmission communication channels described later.

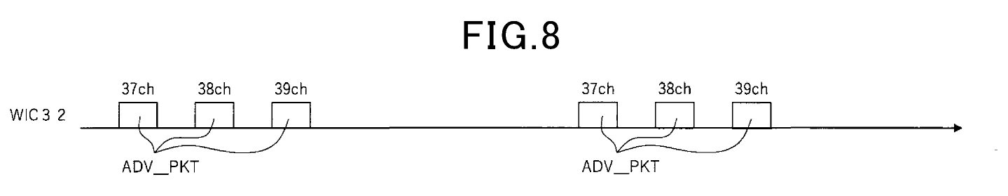

The advertising operation transmits, as shown in FIG. 8, the advertisement packets at predetermined intervals using plural connection-establishment communication channels, such as three channels (channel 37, channel 38, and channel 39 according to the first embodiment). Even if a communication failure occurs in one of the connection-establishment communication channels, the advertising operation can transmit the advertisement packets using the remaining connection-establishment communication channels. For this reason, the three connection-establishment communication channels are established apart from one another in frequency as much as possible so that mutual interference among the three connection-establishment communication channels does not occur (see FIG. 7). Preferably, the connection-establishment communication channels may be established so as not to overlap frequency bands used by other devices.

Returning to the description of the connection-establishment process, let us assume that the primary wireless IC 42 of the battery control device 40 detects, as shown in FIG. 6, an advertisement packet sent from the secondary wireless IC 32 of the battery monitoring device 30, that is, detects the secondary wireless IC 32 by the scan operation in step S13. Then, the primary wireless IC 42 transmits a connection request (CONNECT_REQ) to the detected secondary wireless IC 32 in step S13.

When the secondary wireless IC 32 of the battery monitoring device 30 receives the connection request, a connection of a wireless communication path is established between the battery monitoring device 30 and the battery control device 40 in step S14. Once the connection of the wireless communication path is established, the secondary wireless IC 32 of the battery monitoring device 30 stops transmitting of advertisement packets. The secondary wireless IC 32 of the battery monitoring device 30 periodically transmits advertisement packets until the connection of the wireless communication path is established.

The connection-establishment process may be scheduled to be executed when the battery monitoring devices 30 and the battery control device 40 are powered on. The phrase “powered on” refers to the timing at which operating power is supplied to these devices 30 and 40. For example, in a configuration in which constant power is supplied from the battery block 21 to the devices 30 and 40, the devices 30 and 40 become powered on after manufacturing of the vehicle 10 or after replacement of components at a repair facility. The powered-on timing may also correspond to input of a startup signal, such as an IG signal, output when the ignition switch of the vehicle 10 is turned on. When the ignition switch is turned off, the battery monitoring devices 30 and the battery control device 40 enter a sleep mode, i.e., a standby mode, and may intermittently wake up. The connection-establishment process may also be performed at such intermittent wake-up timing.

When the devices 30 and 40 are powered on, the connection-establishment process is executed between the battery control device 40 and each battery monitoring device 30 that is a connection target for wireless communication with the battery control device 40.

When the wireless communication path, which has been established between the battery control device 40 and any battery monitoring device 30, becomes disconnected, the battery monitoring device 30 and the battery control device 40 execute the connection-establishment process in step S10 again in order to re-establish the wireless communication path therebetween. During this reconnection attempt, the battery control device 40 continues data communication with the remaining battery monitoring devices 30 whose wireless communication paths have already been established. Such a disconnection of the wireless communication path may occur, for example, due to deterioration of the wireless communication environment.

Once the wireless communication path has been established between the battery monitoring device 30 and the battery control device 40, the subsequent data communication processes (steps S20–S33) are executed cyclically between the battery control device 40 and the battery monitoring device 30 without execution of the connection-establishment process unless the battery monitoring device 30 is disconnected. Although the communication procedure described above has been described for the battery monitoring device 30 for ease of description, the same procedure may be performed cyclically for the battery monitoring devices 30 …

More specifically, as shown in FIG. 4, the battery control MCU 41 of the battery control device 40 transmits, to the battery monitoring device 30 whose wireless connection pash has been established, the control data as the control information including a request for acquisition and transmission of the monitoring data including the battery information in step S20.

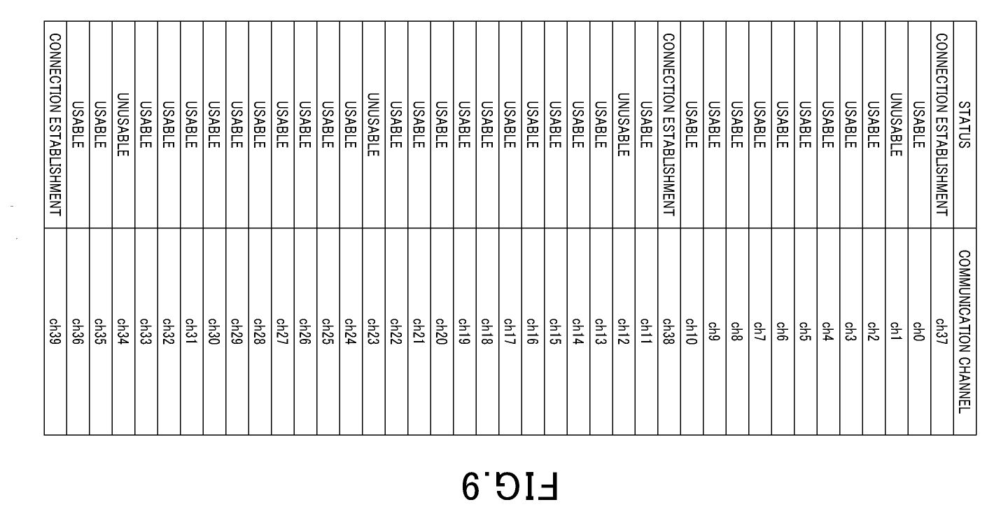

When receiving the control data, the primary wireless IC 42 adds the data required for wireless communication, such as the communication control information, to the control data to accordingly generate transmission data in step S21. Then, the primary wireless IC 42 selects one communication channel from the data-transmission communication channels, that is, the communication channels 0 to 36 in step S22. As shown in FIG. 9, a channel map is provided in which the status of each communication channel is defined. The status of each communication channel is either a usable state (USABLE) or an unusable state (UNUSABLE). The unusable state is also referred to as an unselectable state in FIG. 9. That is, the primary wireless IC 42 refers to the channel map to accordingly select, from the communication channels 0 to 36, one communication channel whose status is the usable state. A method of setting the status of each communication channel is described later.

The primary wireless IC 42 wirelessly transmits the transmission data to the secondary wireless IC 32 of the battery monitoring device 30 via the primary wireless antenna 43 in step S23. At that time, the primary wireless IC 42 uses the selected data-transmission communication channel to transmit the transmission data to the secondary wireless IC 32 therethrough.

When the secondary wireless IC 32 of the battery monitoring device 30 receives the transmission data via the secondary wireless antenna 33, the secondary wireless IC 32 determines whether the communication quality of the communication channel used for the transmission of the transmission data is favorable in step S24. That is, the secondary wireless IC 32 determines whether the transmission data has been normally received.

In step S24, the secondary wireless IC 32 may determine whether a received signal strength indicator (RSSI) of the received transmission data, which denotes the strength of the received transmission data, is lower than or equal to a predetermined strength threshold, and determine that the communication quality is poor, i.e., unfavorable in response to determination that the RSSI of the received transmission data is lower than or equal to the predetermined strength threshold. Because the transmission data includes the error-detection code, the secondary wireless IC 32 may perform a cyclic redundancy check (CRC) of the transmission data to accordingly determine whether the communication quality is unfavorable.

When the transmission data, which is divided into packets, is transmitted to the secondary wireless IC 32, the communication quality may additionally be determined based on whether a packet error rate of the transmission data is lower than or equal to a predetermined error-rate threshold. Additionally, the communication quality may be determined based on a communication time from transmission by the primary wireless IC 42 to reception by the secondary wireless IC 32 or based on variations in the intervals between the successively transmitted packets.

The communication quality may also be determined based on a signal-to-noise ratio (SNR) of the transmission data or using any one of other known methods. A combination of the communication-quality determination methods set forth above may be used to determine the communication quality.

As described above, when receiving the transmission data, i.e., the control data, the secondary wireless IC 32 serves as a communication-quality determination circuitry, i.e., a communication-quality determination circuit or a communication-quality determination processor, that determines the communication quality of the communication channel used for transmission of the transmission data, i.e., the control data. The process in step S24, which is carried out by the secondary wireless IC 32, corresponds to a communication-quality determination process for determining, in reception of the transmission data, i.e., the control data, the communication quality of the communication channel used for transmission of the transmission data, i.e., the control data.

Upon determination that the communication quality of the communication channel used for the transmission of the transmission data is favorable, the determination result in step S24 is affirmative. Otherwise, upon determination that the communication quality of the communication channel used for the transmission of the transmission data is unfavorable, the determination result in step S24 is negative. When the determination result in step S24 is affirmative, i.e., ,the transmission data has been received normally, the secondary wireless IC 32 transmits the control data included in the received transmission data to the monitoring IC 31 in step S25.

When receiving the control data, the monitoring IC 31 performs acquisition, i.e., measurement, of the battery information on each battery cell 22 of the battery block 21 as the monitoring target of the monitoring IC 31 in step S26. In step S26, the monitoring IC 31 may perform failure diagnosis of circuit portions of the battery monitoring device 30.

Next, the monitoring IC 31 transmits the monitoring data including the battery information acquired thereby to the secondary wireless IC 32 in step S27. The monitoring data may include a result of the failure diagnosis together with the battery information.

When the secondary wireless IC 32 receives the monitoring data from the monitoring IC 31, the secondary wireless IC 32 generates transmission data including the monitoring data, that is, response data, and wirelessly transmits, as a response to the control data, the response data to the primary wireless IC 42 via the secondary wireless antenna 33 in step S28. In generation of the response data, the secondary wireless IC 32 may add data required for wireless communication, such as communication control information, to the response data, which is similar to the process of the primary wireless IC 42 in step S21.

Then, the secondary wireless IC 32 selects the same communication channel as the communication channel used when receiving the transmission data sent by the primary wireless IC 42, and wirelessly transmits the response data to the primary wireless IC 42 in step S28. That is, the secondary wireless IC 32 uses the data-transmission communication channel selected in step S22 for transmission of the transmission data. Accordingly, the data-transmission communication channel corresponds to a communication channel for battery-information communication.

Conventionally, when determined the communication quality, the secondary wireless IC 32 always returns the determination result, i.e., the communication quality, to the primary wireless IC 42. In other words, even when the secondary wireless IC 32 cannot receive the transmission data normally, the secondary wireless IC 32 returns the determination result to the primary wireless IC 42. The primary wireless IC 42 then determines the communication quality for each communication channel based on this determination result.

However, even under conditions where the transmission data cannot be normally received, in other words, where the communication quality is unfavorite, the determination result is returned to the primary wireless IC 42 as described above. This may result in an increase in the amount of communication data, causing a vicious cycle of further deteriorating the communication quality. This therefore may cause the communication speed to become even lower and the communication error rate to deteriorate.

From this viewpoint, upon the communication quality of the communication channel used for the transmission of the transmission data in a current cycle being determined to be unfavorable (NO in step S24), the secondary wireless IC 32 of the first embodiment terminates the data communication in the current cycle, and prevents itself from responding, i.e., returning, to the primary wireless IC 42. This suppresses an increase in the amount of communication data on a communication channel whose communication quality is determined to be unfavorable.

As described above, the secondary wireless IC 32 of the first embodiment serves as a returning circuitry, such as a returning circuit or a returning processor, that returns the monitoring data as a control result when the communication quality is determined to be favorable and that prevents itself from returning the monitoring data when the communication quality is determined to be unfavorable. The processes in steps S24 to S38 correspond to a reply process.

As shown in FIG. 5, after transmitting the transmission data in step S23, the primary wireless IC 42 determines whether response data has been returned from the secondary wireless IC 32 as a transmission destination in step S29. Specifically, after transmitting the transmission data in step S23, the primary wireless IC 42 determines whether the response data has been received within a predetermined time.

When the communication quality of the communication channel used for the transmission of the transmission data is unfavorable (NO in step S24) so that the secondary wireless IC 32 prevents itself from returning response data, the determination result in step S29 becomes negative (NO in step S29). Even if the determination result in step S24 is affirmative so that the secondary wireless IC 32 returns the response data, the determination result in step S29 also becomes negative when the primary wireless IC 42 fails to receive the response data due to the occurrence of a communication failure or other failures.

Upon no response data having been returned from the secondary wireless IC 32 (NO in step S29), the primary wireless IC 42 evaluates the communication quality of the communication channel used to transmit the transmission data to the secondary wireless IC 32, that is, the data-transmission communication channel selected in step S22, and stores the evaluation result in the channel map in step S30.

Specifically, the primary wireless IC 42 determines that the communication quality of the data-transmission communication channel selected in step S22 is poor in step S30. When determining that the communication quality of the data-transmission communication channel selected in step S22 is unfavorable, the primary wireless IC 42 of the first embodiment updates, in the channel map, the status of the data-transmission communication channel selected in step S22 as the unusable state (unselectable state) for subsequent data communication in step S30. This results in, in step S22 of a subsequent cycle, the data-transmission communication channel not being selected. After the process in step S30, the primary wireless IC 42 then terminates data communication in the current cycle.

Accordingly, in response to determination that, after transmission of the control data, no monitoring data is returned from the battery monitoring device 30, the primary wireless IC 42 of the first embodiment serves as an evaluation circuitry, i.e., an evaluation circuit or an evaluation processor, that evaluates that the communication quality of the communication channel selected at the time of transmitting the control data is unfavorable. The process in step S30 corresponds to an evaluation process.

Upon the response data having been returned from the secondary wireless IC 32 (YES in step S29), the primary wireless IC 42 determines whether the communication quality of the communication channel used for the transmission of the response data is favorable in step S31. In step S31, the primary wireless IC 42 determines whether the communication quality of the used communication channel is favorable, which is similar to the determination in step S24. Upon determination that the communication quality of the used communication channel is unfavorable so that the determination result in step S31 becomes negative (NO in step S31), the processing of the primary wireless IC 42 proceeds to step S30.

Otherwise, when the communication quality of the used communication channel is determined to be favorable, that is, when having received the response data normally (YES in step S31), the primary wireless IC 42 transmits the monitoring data included in the received response data to the battery control MCU 41 in step S32. The battery control MCU 41 executes one or more predetermined processes based on the monitoring data in step S33. The primary wireless IC 42 then terminates data communication in the current cycle.

As described above, the battery control device 40 cyclically performs the above-described data communication with each battery monitoring device 30 whose connection has been established.

The battery monitoring system 100, the battery monitoring devices 30, the battery control device 40, the wireless communication program, and the wireless communication method of the first embodiment set forth above provide the following advantageous benefits.

When receiving the transmission data including the control data, i.e., the control information, transmitted from the battery control device 40 through a selected communication channel, each battery monitoring device 30, which serves as a receiver, determines whether the communication quality of the communication channel used for transmission of the transmission data is favorable.

Upon the communication quality of the communication channel used for transmission of the transmission data being favorable, the battery monitoring device 30 returns the response data including the monitoring data as a control result. Otherwise, upon the communication quality of the communication channel used for transmission of the transmission data being unfavorable, the battery monitoring device 30 prevents itself from retuning the response data.

This makes it possible to prevent an increase in the amount of communication data that would occur if the battery monitoring device 30 returned the data indicative of the communication quality being unfavorable to the battery control device 40, thus preventing further deterioration of the communication quality.

The battery control device 40, which serves as a transmitter, evaluates, after transmission of the transmission data including the control data as the control information to a communication-partner battery monitoring device 30, that the communication quality of the communication channel used for transmission of the transmission data is unfavorable upon no reception of response data including the monitoring data as the control result from the communication-partner battery monitoring device 30.

Specifically, when having not received repose data within the predetermined time since transmission of the transmitting the transmission data in step S23, the primary wireless IC 42 evaluates that the communication quality of the communication channel used for transmission of the transmission data is unfavorable. This enables the communication-partner battery monitoring device 30 to indirectly notify the battery control device 40 that the used communication channel has poor communication quality, without directly sending any information indicating the communication quality.

The battery control device 40 stores, in the channel map, the status of a communication channel determined to have poor communication quality being the unusable state, i.e., the unselectable state, for subsequent data communication. This prevents communication channels whose communication qualities are unfavorable from being used for subsequent data communication.

The communication channels include the connection-establishment communication channels used to establish wireless communication and the data-transmission communication channels used to exchange battery information. The battery control device 40 evaluates the data-transmission communication channels when the data-transmission communication channels are used. This avoids the connection-establishment communication channels from becoming unusable.

The battery monitoring device 30 selects one of the data-transmission control channels, which has been used to receive the transmission data transmitted from a battery control device 40, and returns response data to the sender battery control device 40. That is, the battery monitoring device 30 returns the response data to the sender battery control device 40 using a communication channel whose communication quality has been determined to be favorable. This prevents the communication quality of a data-transmission communication channel having poor communication quality from being used to return response data, thus preventing further deterioration of the data-transmission communication channel having poor communication quality.

### Second embodiment

The following describes a battery monitoring system 100 according to the second embodiment, a part of the battery monitoring system 100 of the first embodiment has been modified to generate the battery monitoring system 100 of the second embodiment.

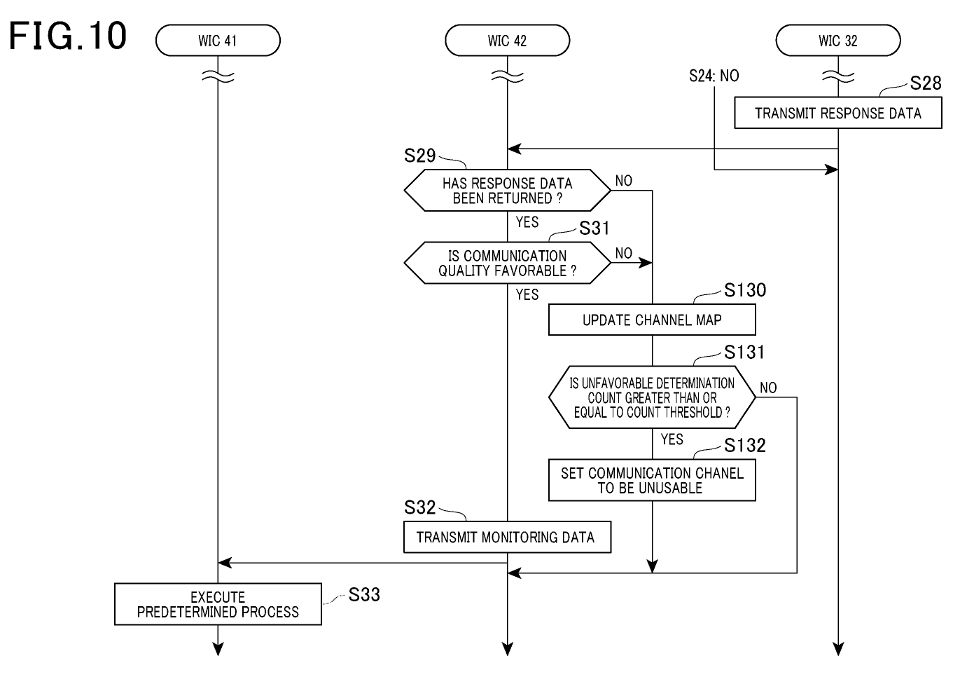

The following describes a modified wireless communication routine according to the second embodiment with reference to FIG. 10, with identical reference numerals assigned to operations of the modified wireless communication routine, which are the same as those of the wireless communication routine according to the first embodiment. Accordingly, the following mainly describes operations of the modified wireless communication routine, which are related to the second embodiment.

When the determination result in step S29 becomes negative (NO in step S29) or the determination result in step S31 becomes negative (NO in step S31), the primary wireless IC 42 evaluates the communication quality of the communication channel used to transmit the transmission data to the secondary wireless IC 32, that is, the data-transmission communication channel selected in step S22, and updates the channel map based on the evaluated communication quality of the communication channel in step S130.

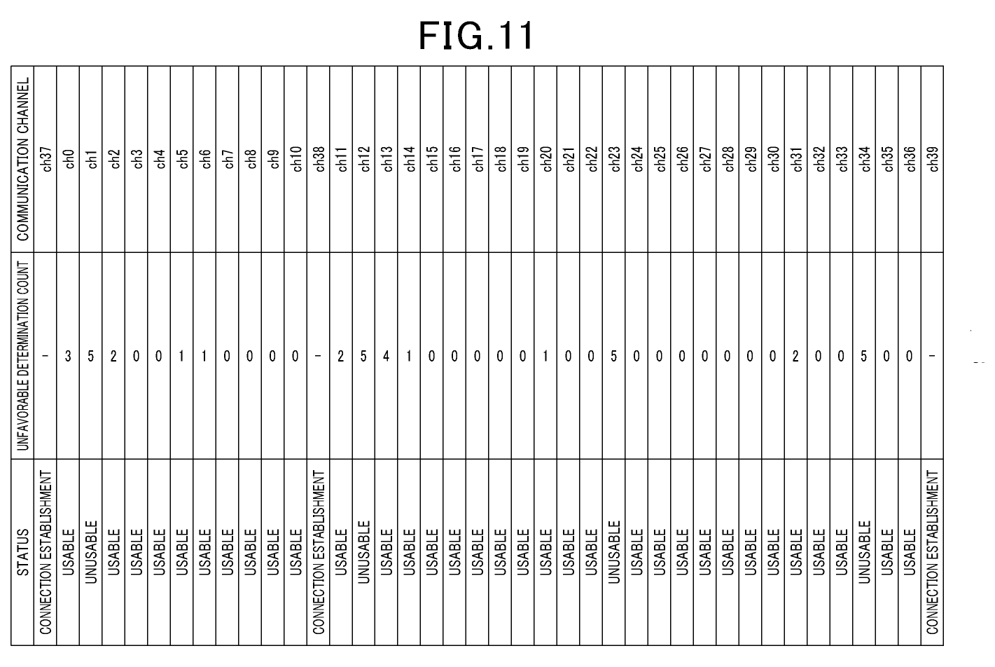

In the channel map illustrated in FIG. 11, an unfavorable determination count is stored for each communication channel. The unfavorable determination count for each communication channel denotes the number of times the communication quality of the corresponding communication channel is determined to be unfavorable.

Specifically, in step S130, the primary wireless IC 42 determines that the communication quality of the data-transmission communication channel selected in step S22 is unfavorable, and increments, by 1, the unfavorable determination count for the data-transmission communication channel selected in step S22.

Next, the primary wireless IC 42 determines whether the unfavorable determination count after the increment is greater than or equal to a predetermined count threshold in step S131. The count threshold can be any value, and is set to 5 according to the second embodiment.

Upon determination that the unfavorable determination count after the increment is greater than or equal to the count threshold (YES in step S131), the primary wireless IC 42 updates, in the channel map, that the status of the data-transmission communication channel selected in step S22 the status of the data-transmission communication channel selected in step S22 as the unusable state (unselectable state) in step S132. For example, as illustrated by communication channels ch1, ch12, ch23, and ch34 in FIG. 11, the unfavorable determination count of any data-transmission communication channel, which is five or more, the status of the data-transmission communication channel is set as the unusable state. This results in, in step S22 in subsequent cycles, the data-transmission communication channel being unselected. The primary wireless IC 42 then terminates the data communication in the current cycle.

Otherwise, if the unfavorable determination count after the increment is smaller than the count threshold (NO in step S131), the primary wireless IC 42 terminates the data communication in the current cycle.

The second embodiment provides the following advantageous benefits.

The communication quality may become poor depending on the external environment around the battery monitoring system 100. For example, relatively large external noise or relatively large vibration of the vehicle 10 due to, for example, road-surface conditions may cause the communication quality to become poor. In such a case, if all communication channels for which the communication quality becomes poor are immediately set to be unselectable, the number of unselectable communication channels may excessively increase, resulting in the selection opportunities of communication channels being limited.

From this viewpoint, the primary wireless IC 42 stores the number of times, which is the unfavorable determination count, the communication quality of each communication channel is determined to be unfavorable, and sets a communication channel whose communication quality is determined to be unusable (unselectable) only when the unfavorable determination count of the communication channel is determined to be greater than the or equal to the count threshold. This therefore makes it possible to reduce the number of unselectable communication channels.

The count threshold according to the second embodiment may be changed as needed. The battery control device 40 may include a threshold setting circuitry, i.e., a threshold setting circuit or a threshold setting processor, that changes the count threshold depending on the state of the vehicle 10 or a communication speed. For example, when the speed of the vehicle 10 as the state of the vehicle 10 is higher than or equal to a predetermined speed, the primary wireless IC 42 may increase the count threshold, for example, increase it from “5” to “7”. Accordingly, even when deterioration of the communication quality (communication environment) is expected due to an increase in vibration transmitted from the vehicle 10 to the battery pack 11 as the vehicle 10 travels at a high speed, it is possible to suppress an unnecessary increase in the number of unselectable communication channels. The speed of the vehicle 10 may be obtained directly from a vehicle speed sensor installed in the vehicle 10 or indirectly via the battery control MCU 41.

When the communication speed is set to be greater than or equal to a predetermined speed, the primary wireless IC 42 may increase the count threshold. That is, even in a case where increasing the communication speed is likely to increase the likelihood that the communication quality will be determined to be poor, it is possible to suppress an unnecessary increase in the number of unselectable communication channels in such a case.

When the vehicle 10 is traveling in an environment with large external noise, for example, when the vehicle 10 is traveling near a radio tower, the primary wireless IC 42 may increase the count threshold. Accordingly, even when deterioration of the communication quality (communication environment) is expected due to traveling in an environment with large external noise, it is possible to suppress an unnecessary increase in the number of unselectable communication channels. Whether the vehicle 10 is traveling in an environment with large external noise may be obtained indirectly via the battery control MCU 41, or the external noise may be measured directly.

The primary wireless IC 42 of each modification serves as the threshold setting circuitry; however, the battery control MCU 41 may serve as the threshold setting circuitry. In this case, the battery control MCU 41 may notify the primary wireless IC 42 of the count threshold.

### Third embodiment

The following describes a battery monitoring system 100 according to the third embodiment, a part of the battery monitoring system 100 of the first embodiment has been modified to generate the battery monitoring system 100 of the third embodiment.

The battery control device 40 of the third embodiment is configured to perform data communication with each of the battery monitoring devices 30, and to determine that an abnormality has occurred in the battery monitoring system 100 or the battery control device 40 upon determination that no response data is returned from the battery monitoring devices 30 within a predetermined period at least a predetermined number of times.

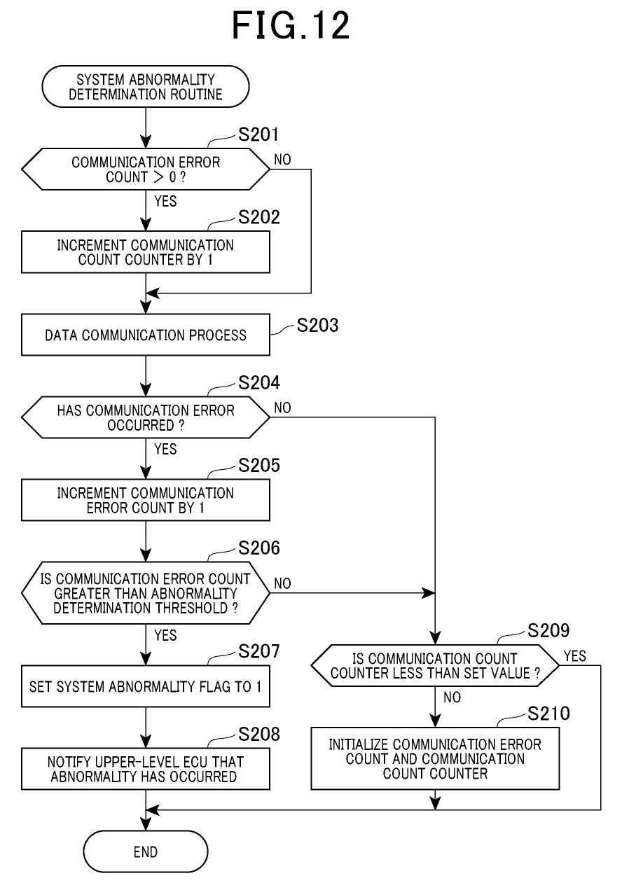

The following describes in detail a system abnormality determination routine according to the third embodiment with reference to FIG. 12. The primary wireless IC 42 is configured to execute the system abnormality determination routine every predetermined cycle, more specifically, every data-communication cycle.

When starting the system abnormality determination routine, the primary wireless IC 42 reads a communication error count and determines whether the communication error count is greater than “0” in step S201 of FIG. 12. The communication error count denotes the number of times the communication quality has been determined to be unfavorable in the data communications described in FIGS. 4 and 5, and is stored in, for example, the primary wireless IC 42. Specifically, the communication error count denotes the number of times the communication quality has been determined to be unfavorable in step S30. The communication error count may also include the number of times the connection-establishment process in step S10 is not normally completed, that is, the number of times a connection between the secondary wireless IC 32 of any battery monitoring device 30 and the primary wireless IC 42 of the battery control device 40 cannot be established.

Upon determination that the communication error count is greater than 0 (YES in step S201), the primary wireless IC 42 increments a communication count counter by 1 in step S202. The communication count counter denotes the number of times the data communication process in step S203 described later, which corresponds to the data communication processes (steps S20-S30), has been performed since the communication error count became non-zero. The communication count counter is stored in, for example, the primary wireless IC 42.

Otherwise, upon determination that the communication error count is not greater than 0 (NO in step S201) or after the process in step S202, the data communication process, which corresponds to the data communication processes (steps S20–S33), is executed in step S203.

If a wireless connection between the battery control device 40 and any battery monitoring device 30 is not established, the connection-establishment process (step S10) is executed before the data communication process in step S203. Otherwise, if the wireless connection between the battery control device 40 and any battery monitoring device 30 has been already established, the process in step S10 is skipped and the data communication process, which corresponds to the data communication processes (steps S20–S33), is executed in step S203.

After execution of the data communication process in step S203, the primary wireless IC 42 determines whether a communication error has occurred in the data communication process in step S204. Specifically, when it is determined in step S30 that the communication quality of the communication channel used to transmit the transmission data to the secondary wireless IC 32

is unfavorable, it is determined that a communication error has occurred. A case where the connection-establishment process is not performed normally may also be determined as a communication error.

Upon determination that a communication error has occurred in the data communication process (YES in step S204), the primary wireless IC 42 increments the communication error count by 1 in step S205.

Next, the primary wireless IC 42 determines whether the updated communication error count is greater than a predetermined abnormality determination threshold in step S206. The abnormality determination threshold is a value more than or equal to 2, such as 5.

Upon determination that the updated communication error count is greater than the predetermined abnormality determination threshold (YES in step S206), the primary wireless IC 42 sets a system abnormality flag to 1 in step S207; the system abnormality flag represents the occurrence of an abnormality in the battery monitoring system 100 or the battery control device 40. The primary wireless IC 42 then notifies an external upper-level ECU, such as the vehicle ECU 14, that an abnormality has occurred in the battery monitoring system 100 or the battery control device 40 in step S208, and terminates the system abnormality determination routine.

Otherwise, upon no communication error has occurred in the data communication process (NO in step S204) or the updated communication error count is less than or equal to the predetermined abnormality determination threshold (NO in step S206), the primary wireless IC 42 determines whether the communication count counter is less than a predetermined set value in step S209. Upon determination that the communication count counter is less than the predetermined set value (YES in step S209), the primary wireless IC 42 terminates the system abnormality determination routine. The set value is, for example, 5.

Otherwise, upon determination that the communication count counter is not less than the predetermined set value (NO in step S209), the primary wireless IC 42 initializes the communication count counter and the communication error count, that is, sets each of the communication count counter and the communication error count to 0 in step S210. That is, when the number of communication errors in cycles of the data communication process in step S203 is less than the abnormality determination threshold during a period from occurrence of a communication error until the communication count counter becomes greater than or equal to the set value, the primary wireless IC 42 determines that no abnormality is present in each of the battery monitoring system 100 and the battery control device 40, and initializes the communication count counter and the communication error count.

The third embodiment described above is configured to determine that an abnormality has occurred in the battery monitoring system 100 or the battery control device 40 upon no response data is returned from the battery monitoring devices 30 multiple times within a predetermined period, making it possible to detect an abnormality of the battery monitoring system 100 or the battery control device 40. Accordingly, the battery control device 40 of the third embodiment serves as an abnormality determination circuitry, such as an abnormality determination circuit or an abnormality determination processor.

### Fourth embodiment

The following describes a battery monitoring system 100 according to the fourth embodiment, a part of the battery monitoring system 100 of the first embodiment has been modified to generate the battery monitoring system 100 of the fourth embodiment.

The battery control device 40 of the fourth embodiment is configured to perform data communication with each of the battery monitoring devices 30, and to determine that an abnormality has occurred in a specified battery monitoring device 30 upon determination that no response data is returned from the specified battery monitoring device 30 within a predetermined period at least a predetermined number of times.

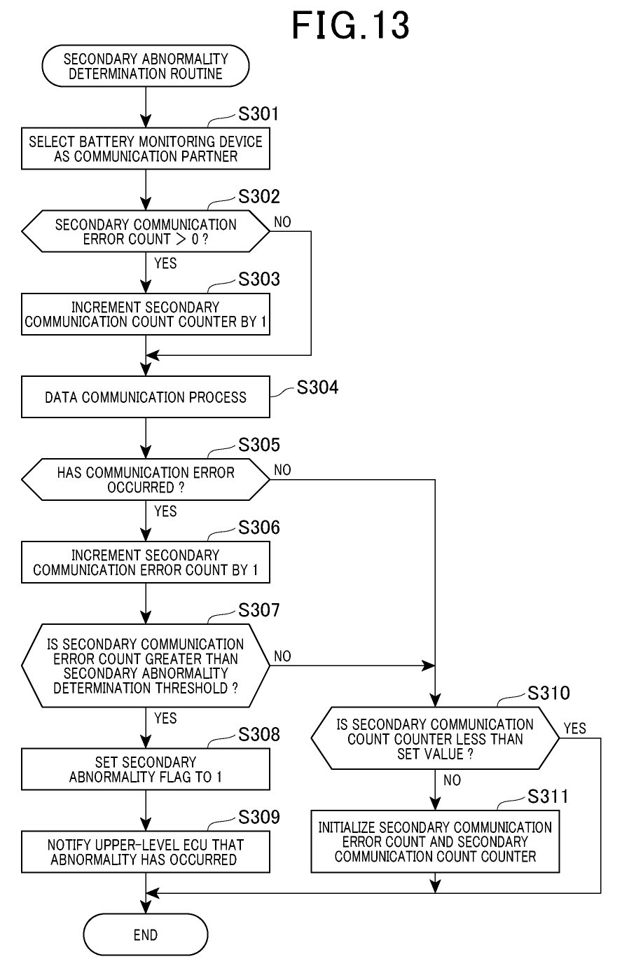

The following describes in detail a secondary abnormality determination routine according to the fourth embodiment with reference to FIG. 13. The primary wireless IC 42 is configured to execute the secondary abnormality determination routine every predetermined cycle, more specifically, every data-communication cycle.

When starting the secondary abnormality determination routine, the primary wireless IC 42 selects one of some communicable battery monitoring devices 30 in a predetermined order as a communication-partner battery monitoring device 30 in step S301 of FIG. 13.

Next, the primary wireless IC 42 reads a secondary communication error count of the selected communicable battery monitoring device 30 and determines whether the secondary communication error count of the selected communicable battery monitoring device 30 is greater than “0” in step S302.

The secondary communication error count for each battery monitoring device 30 denotes the number of times the communication quality related to the corresponding battery monitoring device 30 has been determined to be unfavorable in the data communications described in FIGS. 4 and 5, and is stored in, for example, the primary wireless IC 42. Specifically, the secondary communication error count for each battery monitoring device 30 denotes the number of times the communication quality related to the corresponding battery monitoring device 30 has been determined to be unfavorable in step S30. The secondary communication error count for each battery monitoring device 30 may also include the number of times the connection-establishment process for the corresponding battery monitoring device 30 in step S10 is not normally completed, that is, the number of times a connection between the secondary wireless IC 32 of the corresponding battery monitoring device 30 and the primary wireless IC 42 of the battery control device 40 cannot be established.

Upon determination that the secondary communication error count of the selected communicable battery monitoring device 30 is greater than “0” (YES in step S302), the primary wireless IC 42 increments a secondary communication count counter for the selected battery monitoring device 30 by 1 in step S303. The secondary communication count counter for each battery monitoring device 30 denotes the number of times the data communication process in step S304 described later with respect to the corresponding battery monitoring device 30 has been performed since the secondary communication error count of the corresponding battery monitoring device 30 became non-zero. The secondary communication count counter for each battery monitoring device 30 is stored in, for example, the primary wireless IC 42.

Otherwise, upon determination that the secondary communication error count of the selected communicable battery monitoring device 30 is not greater than “0” (NO in step S302) or after the process in step S303, the data communication process, which corresponds to the data communication processes (steps S20–S33), is executed in step S304.

If a wireless connection between the battery control device 40 and the selected battery monitoring device 30 is not established, the connection-establishment process (step S10) is executed before the data communication process in step S304. Otherwise, if the wireless connection between the battery control device 40 and the selected battery monitoring device 30 has been already established, the process in step S10 is skipped and the data communication process, which corresponds to the data communication processes (steps S20–S33), is executed in step S304.

After execution of the data communication process in step S304, the primary wireless IC 42 determines whether a communication error has occurred in the data communication process between the battery control device 40 and the selected battery monitoring device 30 in step S305. Specifically, when it is determined in step S30 that the communication quality of the communication channel used to transmit the transmission data to the secondary wireless IC 32 of the selected battery monitoring device 30 is unfavorable, it is determined that a communication error between the battery control device 40 and the selected battery monitoring device 30 has occurred. A case where the connection-establishment process between the battery control device 40 and the selected battery monitoring device 30 is not performed normally may also be determined as a communication error between the battery control device 40 and the selected battery monitoring device 30.

Upon determination that a communication error has occurred in the data communication process between the battery control device 40 and the selected battery monitoring device 30 (YES in step S305), the primary wireless IC 42 increments the secondary communication error count of the selected battery monitoring device 30 by 1 in step S306.

Next, the primary wireless IC 42 determines whether the updated secondary communication error count of the selected battery monitoring device 30 is greater than a predetermined secondary abnormality determination threshold in step S307. The secondary abnormality determination threshold is a value more than or equal to 2, such as 5.

Upon determination that the updated secondary communication error count of the selected battery monitoring device 30 is greater than the predetermined secondary abnormality determination threshold (YES in step S307), the primary wireless IC 42 sets a secondary abnormality flag to 1 in step S308; the secondary abnormality flag represents the occurrence of an abnormality in the selected battery monitoring device 30. The primary wireless IC 42 then notifies an external upper-level ECU, such as the vehicle ECU 14, that an abnormality has occurred in the selected battery monitoring device 30 in step S309. In step S309, the primary wireless IC 42 may also notify, for example, the ID of the selected battery monitoring device 30. Thereafter, the primary wireless IC 42 terminates the secondary abnormality determination routine.

Otherwise, upon no communication error has occurred in the data communication process between the battery control device 40 and the selected battery monitoring device 30 (NO in step S305) or the updated secondary communication error count of the selected battery monitoring device 30 is less than or equal to the predetermined secondary abnormality determination threshold (NO in step S307), the primary wireless IC 42 determines whether the secondary communication count counter of the selected battery monitoring device 30 is less than a predetermined set value in step S310. The set value is, for example, 5. Upon determination that the secondary communication count counter of the selected battery monitoring device 30 is less than the predetermined set value (YES in step S310), the primary wireless IC 42 terminates the secondary abnormality determination routine.

Otherwise, upon determination that the secondary communication count counter of the selected battery monitoring device 30 is not less than the predetermined set value (NO in step S310), the primary wireless IC 42 initializes the secondary communication count counter and secondary communication error count of the selected battery monitoring device 30, that is, sets each of the secondary communication count counter and the secondary communication error count of the selected battery monitoring device 30 to “0” in step S311.

That is, when the number of communication errors in cycles of the data communication process in step S203 between the battery control device 40 and the selected battery monitoring device 30 is less than the secondary abnormality determination threshold during a period from occurrence of a communication error until the secondary communication count counter of the selected battery monitoring device 30 becomes greater than or equal to the set value, the primary wireless IC 42 determines that no abnormality is present in the selected battery monitoring device 30, and initializes the secondary communication count counter and secondary communication error count of the selected battery monitoring device 30.

The fourth embodiment described above is configured to determine that an abnormality has occurred in a specified battery monitoring device 30 upon no response data is returned from the specified battery monitoring device 30 multiple times within a predetermined period, making it possible to detect an abnormality of the specified battery monitoring device 30. Accordingly, the battery control device 40 of the fourth embodiment serves as an abnormality determination circuitry, such as an abnormality determination circuit or an abnormality determination processor.

### Modifications

A part of the configuration of the battery monitoring system 100 according to each of the above embodiments may be modified as described below. The following describes the modifications.

In the above embodiments, the primary wireless IC 42 has the function as an evaluation circuitry; however, the battery control MCU 41 may have the function as the evaluation circuitry. Selection of one of the communication channels may be performed by the battery control MCU 41. Similarly, setting the status of at least one of the communication channels to the unselectable state may be performed by the battery control MCU 41.

In the above embodiments, the secondary wireless IC 32 has the function as a communication-quality determination circuitry; however, the monitoring IC 31 may have the function as the communication-quality determination circuitry. Similarly, the secondary wireless IC 32 has the function as a returning circuitry; however, the monitoring IC 31 may have the function as the returning circuitry.

In the third embodiment or the fourth embodiment described above, the count threshold may be changed depending on the distance between a selected communication-partner battery monitoring device 30 and the battery control device 40. Further, the count threshold may be changed depending on shielding performance of the battery pack 11, the size of an internal space of the battery pack 11, or other factors. For example, when the shielding performance is high so that external noise is small, the count threshold may be reduced.

In the above embodiments, the secondary wireless IC 32 may use any communication channel when transmitting the response data.

In step S24 of each embodiment, a threshold, such as the strength threshold or the error-rate threshold used to determine whether the communication quality is poor may be changed. For example, the threshold may be changed depending on the state of the vehicle 10 or the communication speed. Further, the threshold may be changed depending on the distance between a selected communication-partner battery monitoring device 30 and the battery control device 40. Additionally, the threshold may be changed depending on the shielding performance of the battery pack 11 or the size of the battery pack 11.

In the above embodiments, the connection-establishment process in step S10 may be executed while the battery pack 11 is being supplied with electric power from an external charging device outside the vehicle 10. In this modification, the external charging device, instead of the battery control device 40, and the battery monitoring device 30 may execute the connection-establishment process, and the external charging device and the battery monitoring device 30 may perform data communication. That is, the external charging device, instead of the battery control device 40, may obtain and monitor battery information on the battery cells 22.

In the above embodiments, the distance between any battery monitoring device 30 and the battery control device 40 denotes a communication distance between the primary wireless antenna 43 and the secondary wireless antenna 33.

When there are no obstacles between the primary wireless antenna 43 and the secondary wireless antenna 33, the communication distance represents a distance along a straight line connecting the primary wireless antenna 43 and the secondary wireless antenna 33, as illustrated in FIG. 3. Otherwise, when there is an obstacle between the primary wireless antenna 43 and the secondary wireless antenna 33, the communication distance represents the shortest distance along a radio communication path traveled by radio waves travel, considering reflection waves.

In the above embodiments, even when the status of any communication channel becomes unusable (unselectable), the status may be reset at a predetermined timing, for example, when the ignition switch of the vehicle 10 is turned off. The status of any communication channel may also be reset, i.e., initialized, when the state of the vehicle 10 or the communication speed is changed. Further, when at least a predetermined number of communication channels become unusable, the statuses of the unselectable communication channels may be reset.

In the above embodiments, when the status of any communication channel becomes unusable, i.e., unselectable, a communication channel in an adjacent frequency band is also likely to have poor communication quality, and thus the communication channel in the adjacent frequency band may also be set to be unusable. For example, when communication channel ch23 becomes unusable, communication channels ch22 and ch24 may also be set to be unusable.

In the third embodiment described above, when the primary wireless IC 42 is unable to receive monitoring data as a control result from the battery monitoring devices 30 successively a predetermined number of times, the primary wireless IC 42 determines that an abnormality has occurred. Alternatively, when the primary wireless IC 42 is unable to receive monitoring data from the battery monitoring devices 30 a predetermined number of times within a predetermined period, the primary wireless IC 42 may determine that an abnormality has occurred.

In the fourth embodiment described above, when the primary wireless IC 42 is unable to receive monitoring data as a control result from a specified battery monitoring device 30 successively a predetermined number of times, the primary wireless IC 42 determines that an abnormality has occurred. Alternatively, when the primary wireless IC 42 is unable to receive monitoring data from the specified battery monitoring device 30 a predetermined number of times within a predetermined period, the primary wireless IC 42 may determine that an abnormality has occurred.

Each function included in the battery monitoring system 100 and each method carried out in the battery monitoring system 100 according to the present disclosure can be implemented by a dedicated computer including a memory and a processor programmed to perform one or more functions embodied by one or more computer programs.

Each function included in the battery monitoring system 100 and each method carried out in the battery monitoring system 100 according to the present disclosure can also be implemented by a dedicated computer including a processor comprised of one or more dedicated hardware logic circuits.

Each function included in the battery monitoring system 100 and each method carried out in the battery monitoring system 100 according to the present disclosure can further be implemented by a processor system comprised of a memory, a processor programmed to perform one or more functions embodied by one or more computer programs, and one or more hardware logic circuits.

Each function included in the battery monitoring system 100 and each method carried out in the battery monitoring system 100 according to the present disclosure can further be implemented by a hardware logic circuit.

The one or more programs can be stored in a computer-readable non-transitory storage medium as instructions to be carried out by a computer or a processor.

As used herein, “control circuitry” encompasses hardware implemented to perform the described functions, including one or more processors executing instructions, digital logic such as ASICs (“Application Specific Integrated Circuits”) and FPGAs (“Field Programmable Gate Arrays”), or combinations thereof. The phrase “configured to” is used to denote structure arranged to perform the recited function during operation and is not intended to invoke 35 U.S.C. §112(f) absent express “means for” language.

The control circuitry may be implemented in or as part of any one or more of (i) the ICs 31 and 32 of each battery monitoring device 30 and (ii) the battery control device 40. In certain embodiments, different portions of the control circuitry execute on different components and collectively implement the functions described herein.

The control circuitry may be configured to cause an appropriate portion of each battery monitoring device 30 and the battery control device 40 to execute one or more functions as recited in each claim. Such configurations include implementations in which the control circuitry itself executes some or all of the claimed functions.

The following describes characteristic configurations of the present disclosure.

### [First configuration]

A first configuration provides a battery monitoring system (100) for monitoring a battery unit (20, 21, 22). The battery monitoring system includes a transmitter (40) configured to wirelessly transmit control information through a selected communication channel from a plurality of communication channels, and a receiver including a control circuitry (31, 32). The control circuitry is configured to cause the receiver to receive the control information transmitted from the transmitter, execute, in accordance with the control information, at least one control process, determine whether a communication quality of the communication channel used for transmission of the control information in response to reception of the control information is favorable, and return a result of the at least one control process to the transmitter upon determination that the communication quality of the communication channel is favorable.

The control circuitry is configured to cause the receiver not to return the result of the at least one control process to the transmitter upon determination that the communication quality of the communication channel is unfavorable. The transmitter includes an evaluation circuitry (42) configured to determine whether the result of the at least one control process has been returned thereto from the receiver after transmission of the control information, and evaluate that the communication quality of the communication channel used for transmission of the control information is unfavorable upon determination that the result of the at least one control process has not been returned thereto from the receiver.

### [Second configuration]

In a second configuration, which depends from the first configuration, the evaluation circuitry is configured to count, for each of the communication channels, the number of times the communication quality of the corresponding one of the communication channels is determined to be unfavorable. The transmitter is configured to set at least one of the communication channels to be unselectable upon determination that the counted number of times the communication quality of the at least one of the communication channels is determined to be unfavorable is greater than or equal to a predetermined count threshold.

### [Third configuration]

In a third configuration, which depends from the second configuration, the battery unit is installed in a vehicle, and the transmitter includes a threshold setting circuitry configured to change the predetermined count threshold depending on at least one of a state of the vehicle or a communication speed between the transmitter and the receiver.

### [Fourth configuration]

In a fourth configuration, which depends from the third or fourth configuration, the battery unit is installed in a vehicle, and the threshold setting circuitry is configured to change the predetermined count threshold upon at least one of (i) a speed of the vehicle as the state of the vehicle being determined to be higher than or equal to a predetermined speed or (ii) the vehicle is present in an environment in which external noise that causes an influence on wireless communication between the transceiver and the receiver.

### [Fifth configuration]

In a fifth configuration, which depends from any one of the first to fourth configurations, the plurality of communication channels include one or more connection-establishment communication channels and one or more battery-information exchange communication channels. The transmitter is configured to select one of the battery-information exchange communication channels upon transmission of the control information. The evaluation circuitry is configured to evaluate that the communication quality of one of the battery-information exchange communication channels selected by the transmitter.

### [Sixth configuration]

In a sixth configuration, which depends from any one of the first to fifth configurations, the control circuitry of the receiver is configured to return the result of the at least one control process to the transmitter through one of the communication channels used for transmission of the control information by the transmitter.

### [Seventh configuration]

In a seventh configuration, which depends from any one of the first to sixth configurations, the transmitter is a battery control device configured to transmit, as the control information, control data that includes battery-information acquisition request. The receiver is at least one battery monitoring device. The at least one battery monitoring device is configured to receive the control data as the control information transmitted from the transmitter, execute, as the at least one control process in accordance with the control data, an acquisition process of acquiring, from the battery unit, battery information on the battery unit, and return, as the result of the at least one control process, response data indicative of the acquired battery information to the receiver.

### [Eighth configuration]

In an eighth configuration, which depends from then seventh configuration, the at least one battery monitoring device includes multiple battery monitoring devices. The battery control device includes an abnormality determination circuitry configured to determine whether no response data is returned thereto from a specified one of the multiple battery monitoring devices successively a predetermined number of times, and determine that an abnormality has occurred in the specified one of the multiple battery monitoring devices upon determination that no response data is returned thereto from the specified one of the multiple battery monitoring devices successively the predetermined number of times.

### [Ninth configuration]

In a ninth configuration, which depends from the seventh or eighth configuration, the at least one battery monitoring device includes multiple battery monitoring devices, and the battery control device includes an abnormality determination circuitry. The abnormality determination circuitry is configured to determine whether no response data is returned thereto from the multiple battery monitoring devices successively a predetermined number of times, and determine that an abnormality has occurred in the battery monitoring system or the battery control apparatus upon determination that no response data is returned thereto from the multiple battery monitoring devices successively the predetermined number of times.

### [Tenth configuration]

A tenth configuration provides a receiver (30) for a battery monitoring system (100) that monitors a battery unit (20, 21, 22), a transmitter (40) of the battery monitoring system is configured to wirelessly transmit control information through a selected communication channel from a plurality of communication channels. The receiver includes a control circuitry (31, 32) configured to cause the receiver to receive the control information transmitted from the transmitter, execute, in accordance with the control information, at least one control process, determine whether a communication quality of the communication channel used for transmission of the control information is favorable in response to reception of the control information, and return a result of the at least one control process to the transmitter upon determination that the communication quality of the communication channel is favorable. The control circuitry is configured to cause the receiver not to return the result of the at least one control process to the transmitter upon determination that the communication quality of the communication channel is unfavorable.

### [Eleventh Configuration]

An eleventh configuration provides a transmitter (40) for a battery monitoring system (100) that monitors a battery unit (20, 21, 22). A receiver (30) of the battery monitoring system is configured (i) to execute, in accordance with control information, at least one control process, (ii) to determine whether a communication quality of a communication channel used for transmission of the control information is favorable in response to reception of the control information, (iii) to return a result of the at least one control process to the transmitter upon determination that the communication quality of the communication channel is favorable, and (iv) not to return the result of the at least one control process to the transmitter upon determination that the communication quality of the communication channel is unfavorable. The transmitter is configured to transmit the control information to the receiver through the communication channel, and an evaluation circuitry (42) configured to determine whether the result of the at least one control process has been returned thereto from the receiver after transmission of the control information, and evaluate that the communication quality of the communication channel used for transmission of the control information is unfavorable upon determination that the result of the at least one control process has not been returned thereto from the receiver.

### [Twelfth configuration]

A twelfth configuration provides a wireless communication program product for a battery monitoring system (100) that includes a transmitter (40) and a receiver (30) and monitors a battery unit (20, 21, 22). The program product includes one or more non-transitory storage media, and program instructions stored in the one or more non-transitory storage media. The program instructions causing the receiver to execute, in accordance with control information, at least one control process, to determine whether a communication quality of a communication channel used for transmission of the control information is favorable in response to reception of the control information, to return a result of the at least one control process to the transmitter upon determination that the communication quality of the communication channel is favorable, and not to return the result of the at least one control process to the transmitter upon determination that the communication quality of the communication channel is unfavorable. The program instructions cause the transmitter to wirelessly transmit control information through a selected communication channel from a plurality of communication channels, determine whether the result of the at least one control process has been returned thereto from the receiver after transmission of the control information, and evaluate that the communication quality of the communication channel used for transmission of the control information is unfavorable upon determination that the result of the at least one control process has not been returned thereto from the receiver.

### [Thirteenth configuration]

A thirteenth configuration provides a wireless communication method that includes (I) Wirelessly transmitting, by a transmitter, control information through a selected communication channel from a plurality of communication channels (II) Receiving, by a receiver, the control information transmitted from the transmitter; executing, by the receiver, at least one control process in accordance with the control information (III) Determining, by the receiver, whether a communication quality of the communication channel used for transmission of the control information in response to reception of the control information is favorable (IV) Returning, by the receiver, a result of the at least one control process to the transmitter upon determination that the communication quality of the communication channel is favorable (V) Not returning, by the receiver, the result of the at least one control process to the transmitter upon determination that the communication quality of the communication channel is unfavorable (VI) Determining, by the transmitter, whether the result of the at least one control process has been returned thereto from the receiver after transmission of the control information (VII) Evaluating, by the transmitter, that the communication quality of the communication channel used for transmission of the control information is unfavorable upon determination that the result of the at least one control process has not been returned thereto from the receiver.

Although the present disclosure has been described in accordance with the above embodiments, it is to be understood that the present disclosure is not limited to those embodiments or configurations. The present disclosure also encompasses various modifications and equivalents within the scope of the inventive concept. Furthermore, various combinations and forms, which include those having only one element of the above, more than one, or fewer than those, are also included within the scope of the present disclosure.

1. A battery monitoring system for monitoring a battery unit, the battery monitoring system comprising:
a transmitter configured to wirelessly transmit control information through a selected communication channel from a plurality of communication channels; and
a receiver comprising a control circuitry configured to cause the receiver to:
receive the control information transmitted from the transmitter;
execute, in accordance with the control information, at least one control process;
determine whether a communication quality of the communication channel used for transmission of the control information in response to reception of the control information is favorable; and
return a result of the at least one control process to the transmitter upon determination that the communication quality of the communication channel is favorable,
the control circuitry being configured to cause the receiver not to return the result of the at least one control process to the transmitter upon determination that the communication quality of the communication channel is unfavorable,
the transmitter comprising an evaluation circuitry configured to:
determine whether the result of the at least one control process has been returned thereto from the receiver after transmission of the control information; and
evaluate that the communication quality of the communication channel used for transmission of the control information is unfavorable upon determination that the result of the at least one control process has not been returned thereto from the receiver.

2. The battery monitoring system according to claim 1, wherein:
the evaluation circuitry is configured to count, for each of the communication channels, the number of times the communication quality of the corresponding one of the communication channels is determined to be unfavorable; and
the transmitter is configured to set at least one of the communication channels to be unselectable upon determination that the counted number of times the communication quality of the at least one of the communication channels is determined to be unfavorable is greater than or equal to a predetermined count threshold.

3. The battery monitoring system according to claim 2, wherein:
the battery unit is installed in a vehicle; and
the transmitter comprises a threshold setting circuitry configured to change the predetermined count threshold depending on at least one of a state of the vehicle or a communication speed between the transmitter and the receiver.

4. The battery monitoring system according to claim 3, wherein:
the battery unit is installed in a vehicle; and
the threshold setting circuitry is configured to change the predetermined count threshold upon at least one of (i) a speed of the vehicle as the state of the vehicle being determined to be higher than or equal to a predetermined speed or (ii) the vehicle is present in an environment in which external noise that causes an influence on wireless communication between the transceiver and the receiver.

5. The battery monitoring system according to claim 1, wherein:
the plurality of communication channels include one or more connection-establishment communication channels and one or more battery-information exchange communication channels;
the transmitter is configured to select one of the battery-information exchange communication channels upon transmission of the control information; and
the evaluation circuitry is configured to evaluate that the communication quality of one of the battery-information exchange communication channels selected by the transmitter.

6. The battery monitoring system according to claim 1, wherein:
the control circuitry of the receiver is configured to return the result of the at least one control process to the transmitter through one of the communication channels used for transmission of the control information by the transmitter.

7. The battery monitoring system according to claim 1, wherein:
the transmitter is a battery control device configured to transmit, as the control information, control data that includes battery-information acquisition request; and
the receiver is at least one battery monitoring device configured to:
receive the control data as the control information transmitted from the transmitter;
execute, as the at least one control process in accordance with the control data, an acquisition process of acquiring, from the battery unit, battery information on the battery unit; and
return, as the result of the at least one control process, response data indicative of the acquired battery information to the receiver.

8. The battery monitoring system according to claim 7, wherein:
the at least one battery monitoring device comprises multiple battery monitoring devices; and
the battery control device comprises an abnormality determination circuitry configured to:
determine whether no response data is returned thereto from a specified one of the multiple battery monitoring devices successively a predetermined number of times; and
determine that an abnormality has occurred in the specified one of the multiple battery monitoring devices upon determination that no response data is returned thereto from the specified one of the multiple battery monitoring devices successively the predetermined number of times.

9. The battery monitoring system according to claim 7, wherein:
the at least one battery monitoring device comprises multiple battery monitoring devices; and
the battery control device comprises an abnormality determination circuitry configured to:
determine whether no response data is returned thereto from the multiple battery monitoring devices successively a predetermined number of times; and
determine that an abnormality has occurred in the battery monitoring system or the battery control apparatus upon determination that no response data is returned thereto from the multiple battery monitoring devices successively the predetermined number of times.

10. A receiver for a battery monitoring system that monitors a battery unit, a transmitter of the battery monitoring system is configured to wirelessly transmit control information through a selected communication channel from a plurality of communication channels, the receiver comprising:
a control circuitry configured to cause the receiver to:
receive the control information transmitted from the transmitter;
execute, in accordance with the control information, at least one control process;
determine whether a communication quality of the communication channel used for transmission of the control information is favorable in response to reception of the control information; and
return a result of the at least one control process to the transmitter upon determination that the communication quality of the communication channel is favorable,
the control circuitry being configured to cause the receiver not to return the result of the at least one control process to the transmitter upon determination that the communication quality of the communication channel is unfavorable.

11. A transmitter for a battery monitoring system that monitors a battery unit, a receiver of the battery monitoring system is configured (i) to execute, in accordance with control information, at least one control process, (ii) to determine whether a communication quality of a communication channel used for transmission of the control information is favorable in response to reception of the control information, (iii) to return a result of the at least one control process to the transmitter upon determination that the communication quality of the communication channel is favorable, and (iv) not to return the result of the at least one control process to the transmitter upon determination that the communication quality of the communication channel is unfavorable,
the transmitter being configured to transmit the control information to the receiver through the communication channel,
the transmitter comprising an evaluation circuitry configured to:
determine whether the result of the at least one control process has been returned thereto from the receiver after transmission of the control information; and
evaluate that the communication quality of the communication channel used for transmission of the control information is unfavorable upon determination that the result of the at least one control process has not been returned thereto from the receiver.

12. A wireless communication program product for a battery monitoring system that comprises a transmitter and a receiver and monitors a battery unit, the program product comprising:
one or more non-transitory storage media; and
program instructions stored in the non-transitory storage media,
the program instructions causing the receiver:
to execute, in accordance with control information, at least one control process;
to determine whether a communication quality of a communication channel used for transmission of the control information is favorable in response to reception of the control information;
to return a result of the at least one control process to the transmitter upon determination that the communication quality of the communication channel is favorable; and
not to return the result of the at least one control process to the transmitter upon determination that the communication quality of the communication channel is unfavorable,
the program instructions causing the transmitter to:
wirelessly transmit control information through a selected communication channel from a plurality of communication channels;
determine whether the result of the at least one control process has been returned thereto from the receiver after transmission of the control information; and
evaluate that the communication quality of the communication channel used for transmission of the control information is unfavorable upon determination that the result of the at least one control process has not been returned thereto from the receiver.

13. A wireless communication method comprising:
wirelessly transmitting, by a transmitter, control information through a selected communication channel from a plurality of communication channels;
receiving, by a receiver, the control information transmitted by the transmitter;
executing, by the receiver, at least one control process in accordance with the control information;
determining, by the receiver, whether a communication quality of the communication channel used for transmission of the control information in response to reception of the control information is favorable;
returning, by the receiver, a result of the at least one control process to the transmitter upon determination that the communication quality of the communication channel is favorable;
not returning, by the receiver, the result of the at least one control process to the transmitter upon determination that the communication quality of the communication channel is unfavorable;
determining, by the transmitter, whether the result of the at least one control process has been returned thereto from the receiver after transmission of the control information; and
evaluating, by the transmitter, that the communication quality of the communication channel used for transmission of the control information is unfavorable upon determination that the result of the at least one control process has not been returned thereto from the receiver.
